(19) United States
(12) Patent Application Publication
(10) Pub. No.: US 2009/0171476 A1
(43) Pub. Date: Jul. 2, 2009

(54) Control System for Production Machine

(75) Inventor: Amir Aloni, Haifa (IL)

Correspondence Address: Avia Kafri, 22 Shderot Chen Street, Tel Aviv, 64166, IL

(73) Assignee: EMERALD INFORMATION SYSTEMS LTD, MISGAV (IL)

(21) Appl. No.: 12/308,129

(22) PCT Filed: Jun. 6, 2007
(86) PCT No.: PCT/IL07/00683

§ 371 Date: Dec. 8, 2008

Related U.S. Application Data
(60) Provisional application No. 60/804,100, filed on Jun. 7, 2006.

(51) Int. Cl. G05B 19/00

(52) U.S. Cl. 700/7; 700/266

(57) ABSTRACT

A system for controlling cyclic production machines (CPMs) includes a control processor linked to a plurality of controllers. One or more controllers, some of which may also serve as controllers of dispensing and dosing devices feeding the CPM with materials, are coupled to a CPM. An operator interface supporting one or more user stations provides for displaying data to a user. Each controller is linked at least to a timing unit of a respective CPM. One or more sensors whose signals provide indications as to the working parameters of the CPM are further linked to a controller. Gathered signals are temporarily stored in respective controllers to be further transferred to, processed and stored in, the control processor. Working parameters are associated with characteristic profiles and/or statistics to be further stored in the control processor. A user of a CPM may examine the history of a working parameter, the current and/or stored characteristic profiles and statistics; correlate between profiles and/or statistics of different parameters or related to different times. The user may adjust the configuration parameters of the CPM and/or the respective dispensing and dosing devices, such that the current characteristic profile or statistics conform with a pre-stored characteristic profile and/or statistics.

### FIELD OF THE INVENTION

The present invention relates in general to a system and method for controlling a production machine. More particularly the present invention relates to measuring working and environmental parameters of a cyclic production machine, setting up a production machine and controlling its operation.

### BACKGROUND OF THE INVENTION

The exact ratio between components used as input in a chemical process is of crucial importance in the determination of the final properties of the product. Therefore appropriate adjustments are normally applied to the incoming flow of materials consumed at the production process. Common gravimetric dosing and feeding devices provide for accurate dosing and blending ratios of raw materials composing a chemical product. An exemplary gravimetric dosing device (GDD) is disclosed in U.S. Pat. No. 6,688,493. The disclosed GDD consists of a controller, a weighing unit and a feeder. The controller is operative in activating the feeder for dispensing material into the production machine, weighing the dispensed material by means of the weighing unit, calculating weights of dosed portions of dispensed material out of the feeder, and for controlling the size of a dispensed dose, and or the feeding times and rates in which material is fed into the production machine.

A typical BS for feeding materials into production machines is shown in FIG. 1. BS 10 consists of at least one GDD such as is GDD 12 that is coupled to production machine (PM) 14 for feeding with raw material delivered from reservoir 16 containing raw material of type A. Similarly GDD 18 feeds PM 14 with raw material of type B. Often scrap typically stored in scrap reservoir 20 is also fed into PM 14 by means of GDD 22. Products such as made of plastic resigns that do not meet their quality criteria are optionally grinded by means of grinding device 24 and the ground materials are delivered to reservoir 20 to be fed back into PM 14 by means of GDD 22. Some or all GDDs coupled to PM 14 for its feeding are typically linked to feeding processor 30. Feeding processor 30 linked to operator interface 32 provide for controlling the blending ratios of the various materials utilized.

Blending of scrap with virgin raw materials is often implemented in the production process. The blending ratios of scrap with virgin raw material normally impact the level of fluidity of the mix through different stages within a production machine. Such changes in the fluidity of materials may effect some properties of the products. Properly adjusting and fine-tuning the setup parameters of, and uptake of raw materials by, the production machine when utilizing scrap may significantly contribute in lowering the cost of production.

Accommodating the configuration parameters of a production machine to the blending ratios of raw materials while carrying out such chemical process is of an equivalent importance as the proper adjustment of the flow of materials consumed. A cycle of cyclic production machines, such as injection molding machines or blow molding machines of the plastic industry, includes distinct steps in which molten material is first pressurized into a mold; a step of product curing; a step in which the mold is opened for releasing the cured product, and a step in which the mold is closed and gets ready for an identical cycle to be repeated all over again.

Such production machines normally comprise various sensors for measuring working parameters at different stages of the production process and/or at different locations within the production machine. Normally at least some of such parameters are displayed to the operator, by his choice. The parameters are typically displayed across a local monitor linked to the controller of the production machine. The operator may wish to adjust some of the configuration parameters of the production machine in cases in which he or she detects deviations from a characteristic profile associated with any of such working parameters. Normally such adjustments of the configuration parameters of the production machine as well as the configuration parameters of the BS require detailed understanding and intimate knowledge of the production machine and the production process. Normally such know how is unique and is available only to a few experts. Therefore a control system that will assist any staff member in adjusting such setup parameters of a BS and/or a cyclic production machine is called for.

### SUMMARY OF THE INVENTION

The control system (CS) according to the present invention includes a multiplicity of controllers, some of which may respectively serve as the controllers of dispensing and/or dosing devices, such as gravitational dosing devices (GDDs) and volumetric dosing devices, all of which are linked to a control processor. Each such dispensing and dosing device feeds a production machine with one type of raw material at specified doses, at specified points in time during specified time interval and/or at a specified rates.

One or more controllers are coupled to a cyclic production machine (CPM), which may be for example an injection molding or a blow-molding machine in the plastic industry. An operator supervises the production through a user interface of the control processor.

At least one of the controllers coupled to a CPM receives signals from a sensor associated with the CPM for measuring a working parameter. Signals of the sensors provide indications as to the working parameters of the CPM. These signals are periodically sampled by the respective controller. As the working parameters of the GDDs are changeable and are therefore individually sampled by each GDD. Gathered working parameters of the CPM and working parameters of the dispensing and/or dosing devices are time tagged, and temporarily stored in the respective controllers coupled to the CPM.

The working parameters are associated according to the invention with characteristic profiles such as time profile of a pressure measured at a specific location within a CPM. Some of the working parameters are statistically analyzed on the fly, statistical attributes known in the art as statistics, for example mean, standard deviation, minimum and maximum are computed for a number of samples acquired along a specified time interval to be referred to hereinafter as statistics.

Exemplary working parameters of the CPM are: count of machine cycles, product units produced within a specified time interval, lengths of time intervals corresponding to various segments of CPM's cycles, distances along which certain parts of the CPM periodically move, rotational speed of certain members of a CPM, temperature and or pressure values at specific locations within the CPM, power consumption of a CPM, flow rates and capacities of coolant liquids and or pressurized gases fed to a CPM, specific features and or dimensions of product units.

Characteristic profiles and statistics stored in the control processor, as well as histories of a working parameter are presented to the operator by his choice. The operator is able to compare between currently acquired characteristic profiles and statistics with stored characteristic profiles and or standards and associated tolerances. Tuning of the setup parameters of a CPM and or of respective GDD or a blending system coupled to a CPM is carried out according to the invention to bring at least one measured characteristic profile and or statistics to conform with a pre-stored characteristic profile and or statistics.

A control system of the invention is incorporable with any CPM in which the blending ratios of raw materials influence the level of homogeneity of the mixed components of raw material and the flow features of such mix along various stages of processing within the CPM. The system of the invention promotes the control over the production process of such chemical products.

### BRIEF DESCRIPTION OF THE DRAWINGS

FIG. 1 is a scheme of a common blending system;

FIG. 2 is a scheme of a segment of an exemplary control system for cyclic production machines of the invention;

FIG. 3 is a scheme showing a segment of control system for cyclic production machines according to a preferred embodiment of the present invention;

FIG. 4 is a scheme showing a segment of control system for cyclic production machines according to another preferred embodiment of the present invention;

FIG. 5 is a typical pressure time profile measured at the inlet of the mold of an exemplary injection-molding machine;

FIG. 6 is a typical speed distance profile computed for an injection cycle of the exemplary injection-molding machine referred to in FIG. 5;

FIG. 7 is a typical pressure distance profile computed for the same injection cycle of the exemplary injection-molding machine referred to in FIG. 5;

FIG. 8 is a plot of the maximal distance covered by the screw feeding material into the mold of the exemplary injection-molding machine referred to in FIG. 5 during two exemplary time intervals;

FIG. 9 is a typical plot representing the distribution of distances covered by the screw feeding material into the mold of the exemplary injection-molding machine referred to in FIG. 5.

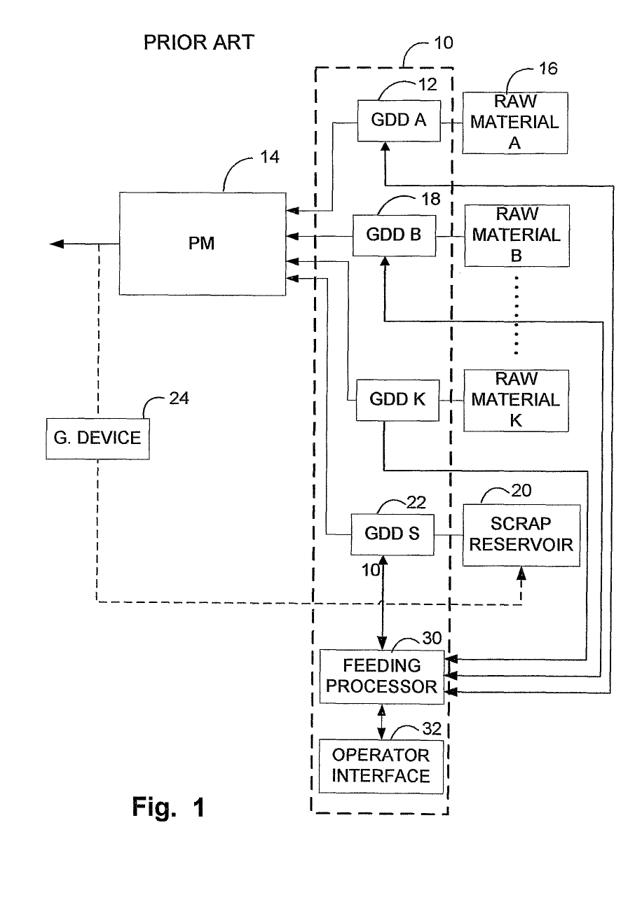

### DETAILED DESCRIPTION OF THE PRESENT INVENTION

In accordance with the present invention a control system for cyclic production machines (CPMs) is provided. Controlling CPMs according to the method of the present invention is accomplished by adjusting configuration parameters of a CPM to conform with a standard or a pre-stored configuration parameters associated with a desired set of blending ratios of raw materials to be consumed along the production process.

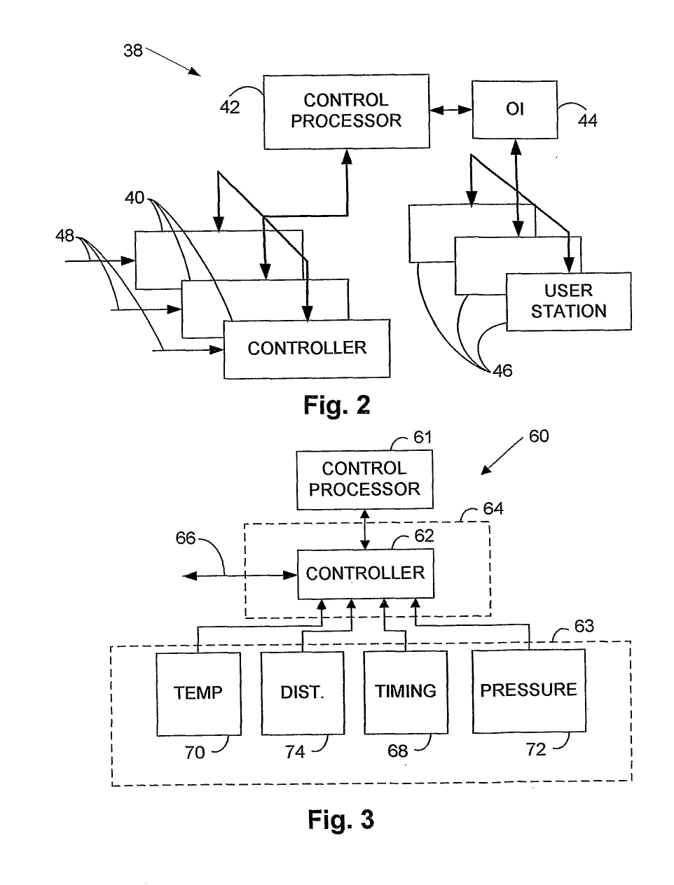

Reference is first made to FIG. 2 schematically showing control system (CS) of the present invention generally designated by 38. A plurality of controllers 40 are linked to control processor 42, which is remote from any of the CPM incorporated and is further linked to operator interface (OI) 44. A plurality means hereinafter as at least one. The operator interface, which is supportive of one or more user stations 46, can be integrally incorporated with the control processor. Each controller of CS 38 is coupled to its respective production machine (CPM), not shown. Coupling a controller to its respective CPM or CPMs is accomplished according to the invention by links 48 each of which provides for measuring signals of two or more sensors, one of which is the timing unit, associated with the respective CPM. The timing unit synchronizes the controller with its coupled CPM. The sensors provide for measuring working parameters of the CPMs. Signals respectively received from the sensors are sampled and temporarily stored in the respective controller to be further transferred to control processor 42 and processed, as is further described infra.

### EXAMPLE 1

For better understanding the CS of the invention an exemplary system configuration to which injection-molding machines such as of the plastic industry are incorporated is hereby described with reference to FIG. 3. Such a CPM is fed for example with two types of virgin raw materials to which scrap is occasionally added as a third type of material utilized in producing a certain line of products. The blending system (BS) employed for feeding the CPM consists of two gravitational dosing devices (GDDs). The GDDs are those disclosed in U.S. Pat. No. 6,688,493, the content of which is incorporated herein by reference. In FIG. 3 a segment of CS 60 is shown. Control processor 61 is linked to controller 62, which is coupled to CPM 63. Controller 62 also serves as the controller of GDD 64 in accordance with a preferred embodiment of the present invention, which is one of the two GDDs respectively feeding CPM 63 with one type of raw material and scrap. Link 66 provides for transferring data, as known, to and from controller 62 to the feeding processor of the blending system (BS), not shown. Controller 62 is linked according to the present invention at least to timing unit 68 of CPM 63. The link to timing unit 68 provides for synchronizing the operation of GDD 64 with the CPM as known. This link also provides according to the present invention for measuring the rate of production accomplished by the CPM along a time interval, and/or the lengths of complete and/or a segment of cycles' times of the CPM. The link between controller 62 and timing unit 68 is further employed as a clock and a timing device linked to controller 62 for timing the measuring of the aforementioned working parameters of CPM 63. Controller 62 is further linked to one or more temperature sensors, such as is temperature sensor 70, for measuring the temperature at various locations within the CPM, or of various elements, such as coolant liquid, oil and or water flowing out of the mold of the CPM, not shown. Controller 62 is also linked to one or more pressure sensors, such as sensor 72 installed within the CPM at the inlet aperture of the mold, for measuring the backpressure exerted by the material contained. A distance sensor 74, such as implemented by measuring electrical conductance or inductance, provides for measuring distances along which the screw feeder of the CPM, not shown, cyclically moves for taking in raw materials, stirring, melting, and delivering, it into the mold.

The current configuration parameters of each GDD respectively feeding a CPM with one type of raw material, or scrap, and/or the BS as well as their stored history, namely data including values of the configuration parameters stored at points in time in which at least one such parameter is modified, doses of materials respectively inputted into the CPM at various machine' cycles, and/or an associated statistics of these doses and/or rates, are also regarded as working parameters of the CPM. Therefore link 66 provides for uploading data from the BS or the other GDDs respectively feeding this CPM related to these working parameters into controller 62. Such data is further incorporated with the data related to GDD 64 stored in controller 62, to be further transferred to control processor 61.

### EXAMPLE 2

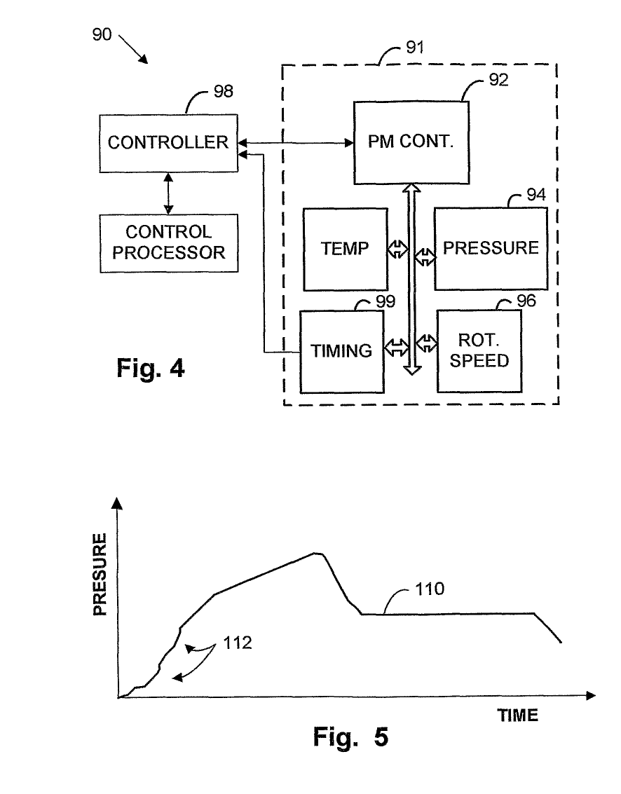

CPMs in which sensors some of which are similar to some of the aforementioned sensors are incorporated linked to the integral CPMs' controller or controllers each of which its signals are periodically measured and gathered by such integral controller or controllers are common. Reference is now made to FIG. 4 schematically showing a segment of CS 90 according to another preferred embodiment of the present invention. CPM 91 is for example one extruder of a blow molding machine in the plastic industry in which its integral controller 92 is linked to sensors such as pressure sensor 94 of its pressure pump and a sensor for measuring rotational speed 96 of its screw feeder. Linking controller 98 separately to each of such sensors is not necessary according to the invention; alternatively linking controller 98 to controller 92, which is the controller of CPM 91, substitutes such separate links. However for synchronizing and for measuring timing parameters of CPM 91, controller 98 is directly linked according to the present invention to the timing unit 99 of CPM 91.

Deriving Working Parameters from Sensor Data

Parameters whose values are indicative to the features of the production process and/or features of a product are regarded as the working parameters of the production machine. Such parameters include according to the present invention parameters related to internal members of a CPM, features of a product unit as well as to environmental conditions, such as ambient temperature. Signals of sensors are used to derive working parameters of the CPM. Sensor signals are periodically acquired, working parameters are derived from them, time tagged and stored in the corresponding controller. Such sensors are normally integrated into the CPM at various locations providing for meaningful data. Such are the aforementioned sensors of the exemplary CS described in example 1 above.

Similarly sensors typically employed for measuring features or dimensions of product units produced by the CPM, as well as sensors for measuring energy and or power consumption of the CPM can be implemented according to the method of the present invention as well. Such sensors may be in contact with the CPM or they may be remote. An example of a remote sensor is an infrared thermometer employed for measuring a temperature of specific member of the CPM or the respective temperatures of product units. Control signals generated by the timing unit of a CPM are regarded according to the invention as a timing sensor. In accordance with some embodiments of the present invention, an operator manually measures features of a product unit such as its color or its weight and feeds the measurements results to the control processor. Such manual measurements when are directly inputted into the control processor by means of a user station, or indirectly inputted to a controller and further transferred to the control processor, are also regarded according to the present invention as being accomplished by the controllers of the CS.

Description of a System According to a Preferred Embodiment of the Present Invention

A CS according to a preferred embodiment of the present invention consists of one or more sets of controllers respectively coupled to one or more CPMs. Each set includes a multiplicity of controllers. Each controller of a set is respectively linked to the timing unit of the respective CPM. One or more controllers of a set are further linked to an additional sensor associated with the respective CPM, which is different from the timing unit. Optionally a controller of a set also serves as a controller of a dispensing and/or dosing device feeding the respective CPM with one type of material. Such a dispensing and/or dosing device can be either a GDD or a volumetric dosing device. In such a case such controller (of a GDD or a volumetric dosing device) need not be according to the invention further linked to a sensor, which is different from the timing unit of the respective CPM.

All the controllers are respectively linked to a control processor. A personal computer (desktop or laptop) may implement the control processor wherein the links to the controllers are implemented by means of a suitable computer communication network as known. Data is periodically and automatically uploaded, or occasionally and manually uploaded by an operator demand, into the control processor. Current and/or historical measured data related to each CPM and its corresponding GDDs and/or volumetric dosing devices, and/or BSes is occasionally displayed by an operator demand across a screen of a user station or a terminal linked to the operator interface, either incorporated into, or linked to, the control processor. The operator may compare such data to other data stored in the control processor. The operator may further correlate a piece of displayed data with other data stored in the control processor. He or she may decide to modify the settings or the configuration parameters of a CPM and/or its corresponding GDDs, volumetric dosing devices and/or BS accordingly, as is further described infra.

Any cyclic CPM for producing chemical products in which the blending ratios of raw materials utilized influence the level of homogeneity of the mixed components of raw material and the flow features of such mix along various stages of processing within the CPM is incorporable with a CS of the invention.

Measured Working Parameters

The values of working parameters of a CPM and the time profiles of such parameters are indicative as to the level of deviations of the product units produced from their specifications. Following is an exemplary list of working parameters to be measured and acquired by a controller according to the present invention: (i) CPM cycles count and the number of produced product units within a time interval; (ii) time intervals corresponding to complete and/or partial cycles of a CPM; (iii) temperature and/or pressure values, measured at different points within the CPM; (iv) distances along which some members of the CPM cyclically, or periodically move; (v) rotational speeds of certain members of a CPM; (vi) specific features of product units measured periodically and/or synchronously with the CPM's cycles, such features measured are associated with dimensions or lengths such as a width of a segment of product unit, or distances between specific points of a product unit, or with weights and/or color of product units or segments of product units; (vii) energy and or power consumption of a CPM, rates of flow and capacities of coolant liquids, and or pressurized gases into a CPM, (viii) quantities of raw materials fed to the CPM by each GDD and/or a BS, (ix) setup or configuration parameters of each GDD, BS and the volumetric dosing devices when are accessible through their integral controller, and or (x) any combination thereof.

The working parameters of the GDDs, volumetric dosing devices and/or BSes and of the CPMs, which are collectively referred herein as the working parameters of a CPM, are amendable and their values impact the production process. Some of the above mentioned working parameters are successively measured according to the method of the present invention at a respective predefined rate along a segment of, or the entire, cycle of the CPM. Such are for example the parameters referred to in categories (iii), (iv), and (vii) described above. Such working parameters are referred hereinafter as parameters measured along the machine cycle. Working parameters of the other categories are sampled according to the present invention in-between machine cycles. All the measured working parameters are timely recorded in the respective controllers. All acquired data are time tagged and are respectively stored within each controller.

All, or a portion, of such time tagged data periodically, or occasionally, such as by an operator demand, is uploaded to the control processor for further processing as is further described infra.

Characteristic Profiles and Statistic

Profiles of working parameters whose functional shapes are indicative to the level of homogeneity of features of currently produced product units are referred to hereinafter as characteristic profiles. Reference is now made to FIGS. 5-7 showing typical time pressure, speed distance, and pressure distance profiles of an exemplary CPM. In FIG. 5, plot 110 of a pressure measured at the inlet of a mold along an injection cycle of an exemplary injection-molding machine is shown. The shape of such a plot is dependent on the blending ratios of the material fed into the CPM for given configuration parameters. The maximal pressure and number, times and sizes of the wiggles such as wiggles 112 at the leading edge of plot 110 are amendable by modifying the configuration parameters of the CPM and or the GDD. The changes in the maximal pressure and the presence and features of such wiggles are indicative of the level of deviations of the currently produced units from their nominal specifications. Therefore such a time pressure profile is a characteristic profile of the CPM.

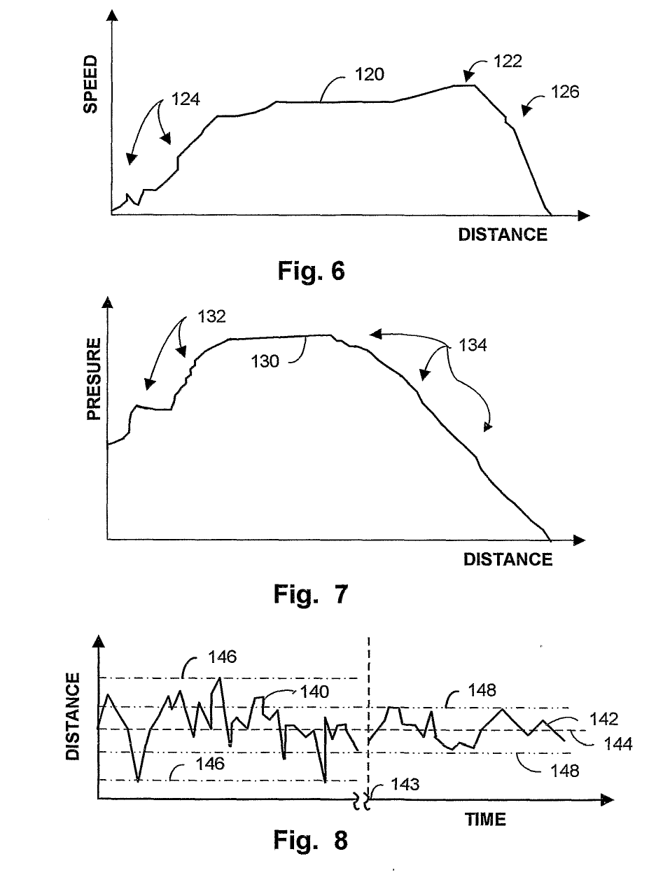

A plot of the measured distance along which the screw feeder of the CPM moves while delivering material into the mold along an injection cycle versus time can be similarly plotted. Differentiating such a time distance profile in time and correlating distances with time values results in another characteristic profile, which is the speed distance profile 120 as is shown in FIG. 6. Maximal speed 122, wiggles 124 along the section of increasing speed with increasing distance and wiggles 126 along the section in which speed decreases with the increasing distance are effected by the values of the configuration parameters of the CPM and by the blending ratios of the mix fed into the CPM.

Combining both aforementioned characteristic profiles and employing the same coordinates transformation of time to distance results in a typical characteristic pressure distance profile 130 corresponding to the same injecting cycle as is shown in FIG. 7. The number and features of wiggles 132 and 134 are effected by the blending ratios of materials fed into the CPM as well as by the values of configuration parameters of this CPM. The extent to which such characteristic profiles deviate from their equivalent typical functional shapes is indicative of the level of deviations of the features of the products from the respective specified values. Therefore, the extent of such deviations can be used as control limits to be displayed to the operator as is further explained infra.

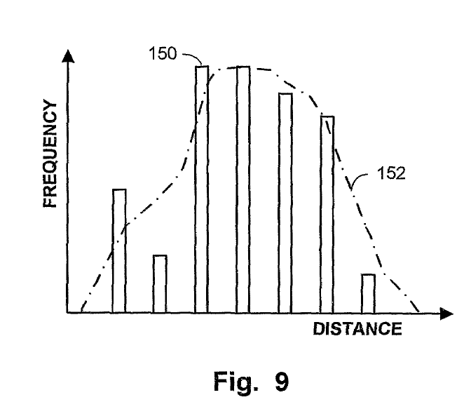

Optionally, the measured values of the working parameters are further statistically analyzed on the fly as seen by reference to FIGS. 8-9. In FIG. 8 typical plots of the maximal distance along which the screw feeding the mold move in successive injecting cycles versus time are shown. Measurements presented are carried out for an exemplary injecting molding machine in which material consisting of virgin main material, one type of master batch and scrap are blended prior to their feeding into the CPM. Curve 140 is a graph of measurements carried out along a first time interval and curve 142 corresponds to measurements made in a second time interval commencing at time 143. Horizontal dashed line 144 presents the average distance that is proportional to the quantity of molten material to be fed into the mold in accordance with the product's quality requirements. Horizontal lines 146 present a region corresponding to a spread of actual measured distances whose separation equals twice the variance of the actual distances relative to the computed average presented by line 144. Pair of horizontal lines 148 presents a statistic corresponding to a distribution of distances if the configuration parameters are adjusted in accordance with the current blending ratios of the materials fed into this CPM as is stored in the control processor. The blending ratios of materials fed into the CPM in both time intervals are the same. However, the configuration parameters of the CPM have been modified by the operator between these two time intervals prior to point in time 143. For such a purpose the operator follows a setup procedure, which is optionally stored in the control processor. Therefore curve 142 of the second time interval conforms better with the statistic presented by line 148. Statistical features related to distributions of working parameters such as the aforementioned statistics represented by lines 144, 146 and 148 are regarded hereinafter as characteristic statistics.

In FIG. 9 an exemplary distribution profile of the distances along which the screw feeding the mold of the same injection molding machine is presented. Both histogram 150 computed for the actual measured values, and curve 152 fitted to these measurements are presented to the operator together with some computed data such as width and some moments of this distribution, not shown. Therefore, an operator is able to compare the currently measured with stored distribution profiles and statistics corresponding to the same product and the same blending ratios.

Changes of the characteristic profiles in time are statistically analyzed in order to assess the level of deviations from their typical values and functional shapes. The integral of pressure along distance, whose value equals the area below the pressure-distance profile shown in FIG. 7 to which reference is again made, computed for each injection cycle is preferable for assessing such deviations. The average, maximal and minimal values and/or the standard deviation computed for this integral along a specified time interval, present characteristic statistics associated with the pressure distance profile.

Another example is associated with the weights of product units computed by employing the measured quantities of raw materials dispensed by some or all the GDDs feeding the same CPM and their respective blending ratios. Such a computation is carried out at each machine cycle in a discrete production process such as of the injection molding, or along consecutive specified time intervals such as in a continuous process as of the extrusion machines in the plastic industry. These computed weights are statistically analyzed along a specified time interval and the resulting average, maximal and minimal computed values and or the computed standard deviation present characteristic statistics associated with the weight of a product unit. Correlating the computed products weights with the values of the backpressure exerted by the material contained within a mold, or with the distance along which the screw feeding the mold moves, may improve the accuracy of the computed weights.

Standard Profiles and Statistics

Each set of blending ratios of materials normally employed for producing a chemical product is associated with a corresponding set of appropriate ranges of values of working parameters of the CPM selected to produce a specific product. The level of conformance of the product's units with their specifications may vary with varying the configuration parameters within these ranges. There are, however, sets of configuration parameters in which the level of deviations from the specified features of a product is permissible. Typically there is a set of configuration parameters in which such level of deviations is minimal for a desired set of blending ratios. The characteristic profiles corresponding to such configuration parameters for each set of blending ratios are regarded according to the present invention as standard profiles.

Some of the features of a characteristic profile are indicative to the level of homogeneity of the product's units. Such as is for example the average distance presented by horizontal line 142 in FIG. 8 to which reference is again made. Similarly, the widths of spread of distances indicated by lines 146 and 148 and/or the aforementioned statistics of working parameters computed on the fly, are indicative as well. Similarly, the statistics of the aforementioned distribution of weights of product units and/or the statistics associated with the aforementioned integrals of pressure along distance, are indicative as well. Such features corresponding to configuration parameters in which deviations from the specified features' values are minimized for a given set of blending ratios are regarded according to the invention as standard profiles and statistics.

Standard profiles and statistics are stored in a database in the control processor according to the invention and are employed as is further described infra.

Control Limits

The current values of some characteristic statistics serve according to the invention as control limits. Control limits are automatically displayed to the operator over the operator station. Such are for example lines 144, 146 and 148 of FIG. 8. Similarly the average, maximal and minimal, values of the aforementioned weights of product units and/or some features of characteristic profiles such as values of the pressure distance integrals can be also used for deriving control limits. Preferably, plots of the currently computed control limits are graphically displayed to the operator together with their standard values. Therefore, a user of a CPM is able to correlate different characteristic and/or standard profiles and statistics and recognize a deviation of the control limits from their desired values.

Adjusting Configuration Parameters of a CPM

The operator can select characteristic profiles and statistics of working parameters from a set of profiles and statistics stored in the control processor. The operator may compare actual characteristic profiles and statistics to pre-stored and/or standard profiles and statistics corresponding to the same CPM, product, blending ratios and a list of raw materials specified by types of materials and optionally by manufacturers. He or she may correlate between characteristic profiles or statistics associated with different working parameters and/or stored at different points in time. Based on such analysis, the operator may evaluate whether by modifying the current configuration parameters of a CPM a match between currently measured profiles with the standard profiles and or statistics is improvable. The operator is optionally assisted by procedures stored in the control processor for such evaluation. Optionally recommendations for further comparisons between other currently measured profiles and statistics and their corresponding standard or pre-stored profiles and statistics that are suitable for the specific product and or materials utilized are presented to the operator by his choice.

The operator is assisted by stored procedures for adjusting some or all of the configuration parameters such that the actual characteristic profiles and/or statistics will better conform with the pre-stored or standard respective items. When the introduction of new configuration parameters is accomplished the operator rechecks the matching between current profiles and statistics of the newly set working parameters with the stored and or standard profiles and statistics. He/she then may improve the setting in a case that the actual profiles deviate from the stored ones by more than is typically advised as is specified in the setting procedure.

Uses of a CS of the Invention

A CS of the invention provides for matching configuration parameters of CPMs and or their GDDs and/or BSes with desired blending ratios of materials composing a chemical product. The utilization of scrap or recycled materials can be promoted by adjusting the configuration parameters of a CPM and/or dispensing and dosing devices to enlarged concentrations of scrap in its input materials. The controllability of the production process is promoted since real time data related to quantities of raw materials utilized, product units produced, and production machines are gathered and stored. Portions of components of raw material consumed can be measured by means of the CS. These quantities combined with computed portions of materials that are not weighed during the production process are optionally documented in the database. Product units are counted and time tagged. Data related to the production process of batches of product units is accessible providing for a detailed quality control process. Time tagged data related to power and energy consumption, capacities of coolant liquids and pressurized gasses are optionally gathered and individually documented for each CPM. Shut down, idle and production times are computable employing individually measured working parameters for each CPM. Such documented data may provide for further analysis and planning of the production process.

1. A remote control system (RCS) for controlling a plurality of cyclic production machines (CPMs), said RCS comprising
at least one local controller coupled to at least one CPM of said plurality of CPMs for acquiring and temporarily storing data related to at least one working parameters associated with said at least one CPM;
a remote control processor having an operator interface, for at least storing data received from said at least one controller, and
wherein said remote control processor connected to said at least one local controller by means of a communication network, and wherein said at least one local controller further linked at least to a timing unit of said at least one CPM.

2. A RCS as in claim 1, wherein said at least one local controller further operative in controlling a dosing device, and wherein said dosing device selected from a group of dosing devices consisting of volumetric and gravitational dosing devices.

3. A RCS as in claim 1, wherein said at least one local controller further linked to at least one sensor, and wherein said at least one sensor is selected from a group of sensors consisting of timing sensors, temperature sensors, pressure sensors, sensors for measuring a distance along which a member of said CPM moves, sensors for measuring at least one feature of a product unit, rotational speed sensors, power sensors, flow sensors, and any combination thereof.

4. A RCS as in claim 1, further comprising at least one operator station linked to said operator interface by which a portion of said data stored in said remote control processor displayed to a user of said RCS.

5. A RCS as in claim 1, wherein said at least one working parameter selected from a group of working parameters consisting of a pressure level measured at a point disposed at a specified location within said CPM, a temperature level measured at a point disposed at a specific location within said CPM, a distance along which a member of said CPM moves, a feature of a product unit, rotational speed of a member of said CPM, a length of a segment of cycle time, a number of machine cycles within a specified time interval, weight of a portion of raw material fed into said CPM along a specified time interval, and any combination thereof.

6. A RCS as in claim 5, wherein said at least one working parameter further selected from a group of product features consisting of a length of a dimension of a product unit, a distance between two points disposed on a surface of a product unit, a color of a segment of a product unit and a weight of a product unit and any combination thereof.

7. A method for controlling a plurality of cyclic production machines (CPMs) consuming raw materials at a respective specified set of blending ratios by means of a remote control system (RCS), wherein data associated with at least one working parameter of at least one of said CPMs acquired by, and temporarily stored in a memory of, at least one local controller coupled to said at least one CPM, said method comprising:
a. transferring at least a portion of said acquired data from said at least one local controller to a remote control processor;
b. processing said transferred data and respectively storing said processed and transferred data in association with said at least one CPM in a memory of said remote control processor;
c. comparing features of selected working parameters with pre-stored features of the respective working parameters associated with the respective specified set of blending ratios, and
d. adjusting configuration parameters of said at least one CPM to conform with the configuration parameters associated with said pre-stored features of the respective working parameters, and
wherein said RCS comprises
a said remote control processor;
said at least one local controller coupled to said at least one CPM, and wherein said at least one local controller linked at least to a timing unit of said at least one CPM, and
at least to one operator station linked to an operator interface of said remote control processor, and
wherein said transferring accomplished by means of a communication network.

8. A method as in claim 7, further comprising measuring values associated with at least one working parameters of said at least one CPM, and wherein said measuring is successively accomplished at a predefined rate along a segment of a cycle of said at least one CPM.

9. A method as in claim 8, and wherein said measuring is further successively accomplished at a predefined rate in between cycles of said at least one CPM.

10. A method as in claim 7, and wherein said at least one local controller further operative in controlling a dosing device feeding said CPM with material.

11. A method as in claim 7, wherein said at least one working parameter selected from a group of working parameters consisting of a pressure level measured at a point disposed at a specified location within said CPM, a temperature level measured at a point disposed at a specific location within said CPM, a distance along which a member of said CPM moves, a feature of a product unit, rotational speed of a member of said CPM, a length of a segment of cycle time, a number of machine cycles within a specified time interval, weight of a portion of raw material fed into said CPM along a specified time interval, and any combination thereof.

12. A method as in claim 7, wherein said processing provides for deriving any feature of at least one working parameter selected from a group of features consisting of a history of values of said at list one working parameters, characteristic profiles associated with said at least one working parameter, statistics associated with said at least one working parameter, and any combination thereof.

13. A method as in claim 7, and wherein said features further selected from a group of features of a product unit including a length of a dimension of a product unit, a distance between two points disposed at a surface of a product unit, a weight of a product unit, a colour of a segment of a product unit, and any combination thereof.

14. A method as in claim 8, and wherein at least one of said controllers further controls a gravitational dosing device feeding said CPM with material.

15. A method as in claim 8, and wherein at least one of said controllers further controls a volumetric dosing device feeding said CPM with material.
